(19) United States
(12) Patent Application Publication
(10) Pub. No.: US 2025/0077288 A1
(43) Pub. Date: Mar. 6, 2025

(54) SYSTEMS AND METHODS FOR EVALUATING STRATEGY USING UNIFIED POOL

(71) Applicant: PAYPAL, INC., San Jose, CA (US)

(72) Inventors: Prabin Patodia, Bangalore (IN); Rajendra Bhat, Bangalore (IN)

(21) Appl. No.: 18/514,275

(22) Filed: Nov. 20, 2023

(30) Foreign Application Priority Data
Sep. 1, 2023 (IN) 202341058888

(51) Int. Cl. G06F 9/50

(52) U.S. Cl. CPC G06F 9/5027

(57) ABSTRACT

There are provided systems and methods for evaluating strategies at a unified strategy evaluation pool. An example system may receive, from a decision service pool at a unified strategy evaluation pool, a request associated with a service. The request includes a context identifier associated with the service, and the unified strategy evaluation pool evaluates the request independently from the decision service pool. The system may evaluate a strategy associated with the service for processing the request based on data associated with the context identifier and data associated with the strategy. The strategy may include a set of rules for evaluating the request. The system may generate an evaluation result of the strategy based on the evaluation. The system may output the evaluation result of the strategy for a determination of whether to send the strategy from the unified strategy evaluation pool to the decision service pool.

### CROSS REFERENCE TO RELATED APPLICATION

The present invention claims priority to India Provisional Patent Application No. 20/234,1058888, filed Sep. 1, 2023, which is incorporated herein by reference in its entirety.

### TECHNICAL FIELD

The present application generally relates to evaluating strategies using a unified pool, and more specifically, to evaluating strategies sent from multiple service pools in a single unified evaluation pool.

### BACKGROUND

Users may utilize computing devices to access online domains and platforms to perform various computing operations. In general, these operations are provided by service providers, which may provide services for account establishment and access, messaging and communications, electronic transaction processing, and other types of available services. During use of these computing services, the service provider may utilize one or more decision services that implement and utilize coded processing rules and/or artificial intelligence (AI) models for decision-making in real-time data processing, such as within a production computing environment. A particular decision service may be associated with providing decision-making operations within a production computing environment, such as live electronic transaction processing operations with an online transaction processor.

The service provider may utilize decision services to process data requests and loads for different outputs (e.g., authentication, risk or fraud analysis, electronic transaction processing, etc.). Upon receiving a request, a decision service may begin populating a workflow to process the request, and evaluate a strategy in response to a potential fraud occurred during processing the request. However, a risk-based fraud detection strategy changes frequently, and it requires a proper evaluation with live data before deploying changes (e.g., the strategy) in the production computing environment. Furthermore, it is costly and bandwidth-consuming to evaluate a strategy live in the production computing environment when a service provider deploys hundreds of decisioning services. Therefore, a solution to reduce maintenance costs and computer resources for evaluating strategies is desirable.

### BRIEF DESCRIPTION OF THE DRAWINGS

FIG. 1 is a block diagram of a networked system suitable for implementing the processes described herein, according to an embodiment;

FIG. 2 is an exemplary diagram of a data flow for evaluating strategies sent from an execution module at an evaluation module, according to an embodiment;

FIG. 3 is an exemplary diagram of a data flow for evaluating strategies sent from a service pool at a unified strategy evaluation pool, according to an embodiment;

FIG. 4 is a flowchart of an exemplary process for evaluating strategies at an unified strategy evaluation pool, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for evaluating strategies in a unified strategy evaluation pool dependent from a production computing environment. As discussed above, the methods and systems are provided to efficiently provide a live evaluation for strategies from multiple service pools at a unified strategy evaluation pool, without a traffic impact in the production computing environment.

A service provider may provide different computing resources and services to users through different websites, resident applications (e.g., which may reside locally on a computing device), and/or other online platforms. When client devices utilize the computing services of a particular service provider, the client devices may connect with servers of the service provider that process requests and provide responses for the corresponding computing services and resources, and the service provider may provide decision services for implementing rules and intelligent (e.g., ML or other AI-based) decision-making operations with such services. For example, an online transaction processor may provide services associated with electronic transaction processing, including account services, user authentication and verification, digital payments, risk analysis and compliance, and the like. The servers and systems for decision-making operations may implement risk rules with a risk engine for detecting an indication of fraud for different servers and/or instances of such servers in a pool or cluster (e.g., virtualized servers or other resources, such as in cloud computing environments with pools of machines or computes serving users). When an indication of fraud is present in a digital transaction and payment, the servers and systems therefore determines whether to proceed with processing the transaction or decline the transaction (as well as additional operations, such as request further authentication and/or information for better risk analysis). Thus, decision services automate repeatable decisions based on decision modeling capabilities so that computing services may execute and perform operations requested by a user's computing device.

In this regard, a user may utilize online service providers, such as transaction processors, via their available online and networked digital platforms that provides computing services through server instances for processing applications, platforms, and operations. The user may desire to make a payment to another user or otherwise transfer funds using the online platforms of the service providers. For example, a user may wish to process a transaction, such as for a payment to another user or a transfer. A user may pay for one or more transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with funds or funds may otherwise be added to the account or digital wallet. The application or website of the service provider, such as PAYPAL® or other online payment provider, may provide payments and the other transaction processing services via the account and/or digital wallet.

The online payment provider may provide digital wallet and transaction processing services, which may offer financial services to send, store, and receive money, process financial instruments, and/or provide transaction histories, including tokenization of digital wallet data for transaction processing. The service provider and/or other service providers may also provide additional computing services, including social networking, microblogging, media sharing, messaging, business and consumer platforms, etc. These computing services may be deployed across multiple different websites and applications for different operating systems and/or device types. Furthermore, these computing services may utilize the aforementioned server resources when processing data from client devices, such as when responding to connection and data processing requests. For example, access and use of these accounts, wallets, transaction processors, and the like may be performed in conjunction with the aforementioned server resources.

The user may utilize the account and/or other computing services provided by the service provider via one or more client computing devices, such as a personal computer, tablet computer, mobile smart phone, or the like. When engaging in these interactions with the service provider, the service provider may utilize servers to process data requests and provide responses or other outputs. Servers may execute one or more computing tasks that process data from a data processing request and output a response to client devices. For example, computing tasks may correspond to executable code, operations, and/or models that may include a client device request processor, a compute for business rules, a data loader, a validation of a data load of the data processing request, a user authenticator, or a response builder for a decision, although other tasks may also be used. In this regard, servers may perform computing tasks that obtain an intended result based on a provided data load for a data processing request.

A data processing request may be a request from a client computing device, such as an end user or customer of the service provider system, which may request use of a computing service and provide a data load for processing. For example, a data processing request may be associated with a particular request for use of a computing service for account login, authentication, electronic transaction processing, risk or fraud, and other ones of the aforementioned computing services. Computing services may correspond to those provided via servers that are utilized by computing devices and may include computing platforms, architectures, and other systems for key-value stores, risk and fraud analysis, transaction processing, intelligent computes (e.g., artificial intelligence (AI), such as machine learning (ML) or neural network (NN) systems), servers hosting decision services and microservices, and the like. The services may be provided to client device through service discovery, which includes identification of a corresponding server instance for the requested computing service (e.g., an instance of the software and operations running or executing on a single physical or virtual server, machine, or other physical or virtualized resource). The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and other transaction processing services. In some embodiments, the service provider and/or other service providers may include multiple services, such as additional computing services, including social networking, microblogging, media sharing, messaging, business and consumer platforms, etc. These computing services may be deployed across multiple different websites and applications for different operating systems and/or device types. Furthermore, these computing services may utilize the aforementioned decision services when determining decisions during data processing. For example, access and use of these accounts may be performed in conjunction with the aforementioned decision services.

Thus, the user may utilize the account and/or other computing services provided by the service provider via one or more computing devices, such as a personal computer, tablet computer, mobile smart phone, or the like, and may engage in one or more transactions with a recipient, such as a recipient account or digital wallet that may receive an amount of a payment. When engaging in these interactions, the service provider may utilize the corresponding decision services to process data requests and loads and provide a decision or other output. However, a strategy for detecting risk-based fraud when processing these request may be constantly changed, and therefore may require a proper evaluation before deploying. A detailed evaluation for the strategy may consider multiple factors, e.g., performance of strategy, fire rate, action rate, decision quality, and fraud pressure, tuning, resource utilization, etc., to ensure a proper deployment of the strategy. In addition, live data associated with the decision services can be dynamic in nature, and it may be costly (e.g., computing efficiency) and affectable (e.g., traffic jam) if the strategy is being evaluated in the same environment where the decision services are being processed, especially for a service provider like PayPal® which provides hundreds or more decision services.

In this regard, the service provider may establish a separate, independent environment which may simulate the same or a similar environment as the operating environment of the decision service for evaluating strategies. This evaluation pool (e.g., a unified strategy evaluation pool) may manage all decision services and evaluate all the strategies for the decision services. For example, the service provider may provide decision services (e.g., multiple service pools in a production environment) for establishing an online account, making a transfer, messaging through a social media account, etc. Therefore, it may be beneficial to establish a similar environment for evaluating the strategies that operates independently from the production environment. The unified strategy evaluation pool may receive multiple requests from different service pools, e.g., a request to establish an online account at a service pool for running social media accounts and interactions, a message sent to another user at another service pool for an external messaging service, and the like. The requests sent from the service pools may be generated/duplicated based on the original requests received at the service pools, and the duplicated requests received at the unified strategy evaluation pool may be evaluated for their strategies. The duplicated requests may include identifiers corresponding to the original requests and necessary live data received at the service pools, such that the evaluations for multiple service pools may be done efficiently at the unified pool using live data without affecting traffic at the service pools before deploying at the service pools.

As previously discussed, decision services may be impacted due to traffic congestion or limited bandwidth when evaluating strategies in the same environment and evaluating the strategies using live data can be costly (e.g., computing performance, processing speed, etc.), especially with a platform that carries hundreds of services. As such, a service provider may utilize the unified strategy evaluation pool to evaluate a strategy more efficiently and with less interference with the production computing environment. In this way, multiple strategies may be evaluated in a similar and yet separate environment using live data to ensure the accuracy and proper function of the strategy without affecting processing bandwidth at the service pool. Furthermore, since the unified strategy evaluation pool may execute rules associated with the proposed strategies all together at a specific time frame (e.g., based on the need at the service pool, such as a preset time duration to deploy/renew a strategy), the unified strategy evaluation pool may reduce maintenance costs and improve computing efficiency.

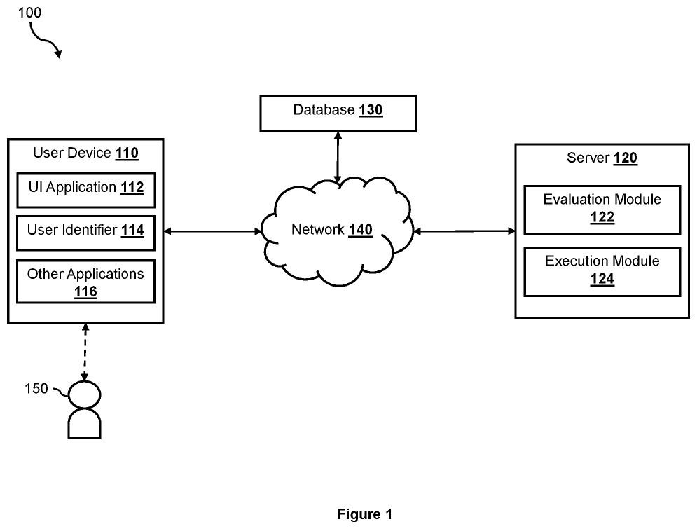

FIG. 1 illustrates an exemplary machine learning system 100, within which a method for evaluating a strategy at a unified strategy evaluation pool may be implemented according to some embodiments of the disclosure. A system 100 may include a user device 110, a server 120, and a database 130 that may be communicatively coupled with each other via a network 140. The server 120, in one embodiment, may include an evaluation module 122 and an execution module 124 for evaluating a strategy (e.g., a request sent from the user device 110). The database 130, in one embodiment, may be a database storing a plurality of datasets associated with the strategy (e.g., data associated with the request, such as user information of the user device 110, etc.) which are accessible by the server 120. The network 140, in one embodiment, may be implemented as a single network or a combination of multiple networks. For example, in various embodiments, the network 140 may include the internet and/or one or more intranets, landline networks, wireless networks, and/or other appropriate types of communication networks. In another example, the network 140 may comprise a wireless telecommunications network (e.g., cellular phone network) adapted to communicate with other communication networks, such as the Internet.

The user device 110, in one embodiment, may include a user interface (UI) application 112 (e.g., a web browser, a mobile payment application, etc.), which may be utilized by a user 150 to interact with the server 120 over the network 140. In one implementation, the user interface application 112 may include a software program (e.g., a mobile application) that provides a graphical user interface (GUI) for the user 150 to interface and communicate with the server 120 via the network 140. In another implementation, the user interface application 112 may include a browser module that provides a network interface to browse information available over the network 140. For example, the user interface application 112 may be implemented, in part, as a web browser to view information available over the network 140. Thus, the user 150 may use the user interface application 112 to initiate electronic transactions (e.g., login transactions, data access transactions, profile establishment, etc.) with the server 120.

For example, the user 150 may, via the user device 110, log into their account and request a transaction (e.g., making a payment) via the server 120. The server 120 may determine a set of data associated with the transaction, such as data provided by the user 150 via the user device 110, data associated with the user device 110, and data associated with the user 150, and send the gathered data to the server 120 to be parsed and evaluated. For example, the execution module 124 of the server 120 may textually parse contents in the data associated with the transaction (e.g., an account number, the amount of the payment, a transaction history associated with the user device 110, an IP address of the user device 110, etc.), generate a workflow to process the data associated with the transaction in the request, and send a duplicated request to the evaluation module 122 for evaluating the request (e.g., evaluating a new strategy for the service based on the request). In some embodiments, the evaluation module 122 and the execution module 124 may be implemented with a machine learning model trained and built to perform a specific task (e.g., performing the service associated with the request and evaluating a risk of the request). The evaluation module 122 may then send the output (e.g., results of the evaluation) back to the execution module 124 to proceed with a corresponding action based on the output, e.g., deploying a new strategy, declining the transaction, approving the transaction, adjusting rules for processing the transaction, or taking additional authentication steps based on the output risk evaluation.

The user device 110 may include other applications 116 as may be desired in one or more embodiments of the present disclosure to provide additional features available to the user 150. In one example, such other applications 116 may include security applications for implementing client-side security features, programmatic client applications for interfacing with appropriate application programming interfaces (APIs) over the network 140, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the server 120 via the network 140, and the identifier 114 may be used by the server 120 to associate the user 150 with a particular user account (e.g., and a particular profile).

In various implementations, the user 150 may be able to input data and information into an input component (e.g., a keyboard) of the user device 110. For example, the user 150 may use the input component to interact with the UI application 112 (e.g., to conduct a purchase transaction via the server 120).

The database 130 may store one or more datasets, for example, including data associated with the user device 110 and/or the user 150 (e.g., IP address of the user device 110, transaction history of the user 150, etc.), and data associated with a corresponding service performed at the server 120 (e.g., criteria for performing a service, rules for evaluating a strategy associated with the server, etc.) for various machine learning models maintained by the server 120 to perform various tasks. The various machine learning models may be trained and built by the server 120, and may be used by the server 120 for performing a task of evaluating a strategy at the evaluation module 122. In some embodiments, the database 130 may store multiple set of rules associated with different services and strategies, which are accessible to the evaluation module 122 and the execution module 124. In some embodiments, the database 130 may store the datasets associated with a user profile of the user 150 to analyze recurring patterns in transactions made by the user 150, so that when the evaluation module 122 of the server 120 receives a request (e.g., a duplicated request duplicated based on a request received at the execution module 124), the evaluation module 122 may retrieve data that is necessary for evaluating the strategy proposed in response to a potential risk/fraud, e.g., retrieving a transaction history of the user 150 which is to be compared with contents (e.g., work flow) in the duplicated request to determine whether there is a potential fraud involved.

The server 120, in various embodiments, may be any of various types of computer servers, e.g., a cluster of computers in a server farm, capable of serving data to other computing devices, including user device 110, via network 140. The server 120 may be associated with different types of entities or systems, such as, but not limited to, various service providers, including payment or transaction service providers. In some embodiments, the server 120 may include the evaluation module 122, the execution module 124, and an internal database to store data associated with services implemented at the execution module 124.

Upon receiving an input (e.g., a request for establishing a user profile at PayPal®) from the database 130 or from the user 150 via the user device 110 at the execution module 124, the execution module 124 may obtain data that is necessary to process the input (e.g., fetching a user profile established at other online payment provider that matches the contents in the request). The execution module 124 may then populate a workflow based on the input and the obtained data. At the same time, the execution module 124 may apply rules associated with the service (e.g., requirements proceed with the input request) to the input, and duplicate the input that may be sent to the evaluation module 122 for an evaluation, such that the traffic running at the execution module 124 may not be affected. The execution module 124 may proceed with the input (e.g., applying the rules to the request) to determine if there is any rule against proceeding with the input. The execution module 124 may then proceed with processing the input in response to the results of applying the rules to the input (e.g., approving the request or declining the request).

While the execution module 124 is processing the input request, the evaluation module 122 may identify and validate the duplicated input sent from the execution module 124. In some embodiments, the duplicated input may include a identifier associated with the workflow generated based on the input and a parent identifier associated with the input, such that the evaluation module 122 may validate that the duplicated input is associated with a service provided by one of the service pools implemented at the execution module 124, and determine a strategy (e.g., a new strategy to be implemented at a corresponding service pool in response to a new pattern of scam) based on live data included in the duplicated input. The evaluation module 122 may retrieve rules associated with the strategy from the database 130. In some embodiments, the evaluation module 122 may determine whether additional data (e.g., a bank account associated with the user 150 who makes the input) is needed to determine whether the strategy is applicable at the execution module 124. In some embodiments, the evaluation module 122 may execute the rules associated with the strategy or any other strategies for other services together at or before a designated time (e.g., a default time to renew the policy at the execution module 124) to reduce traffic consumption and computing cost. The evaluation module 122 may determine a decision in response to the strategy (e.g., sending the strategy back to the execution module 124 to be applied at the corresponding service pool implemented at the execution module 124). When the evaluation module 122 completes the evaluation for the strategy, the evaluation module 122 may output a result of the evaluation which may be logged for a comparison to check the efficiency of the strategy (e.g., the newly-proposed strategy). In some embodiments, the result of the evaluation may be for a user 150 (e.g., administrator, rule writer, other user configuring decision services, etc.) to review and implement or revise strategies. In some embodiments, the evaluation module 122 may further implement an automated strategy release, such that in response to meeting certain thresholds or benchmarks, the evaluation module 122 may release the strategy to the execution module 124.

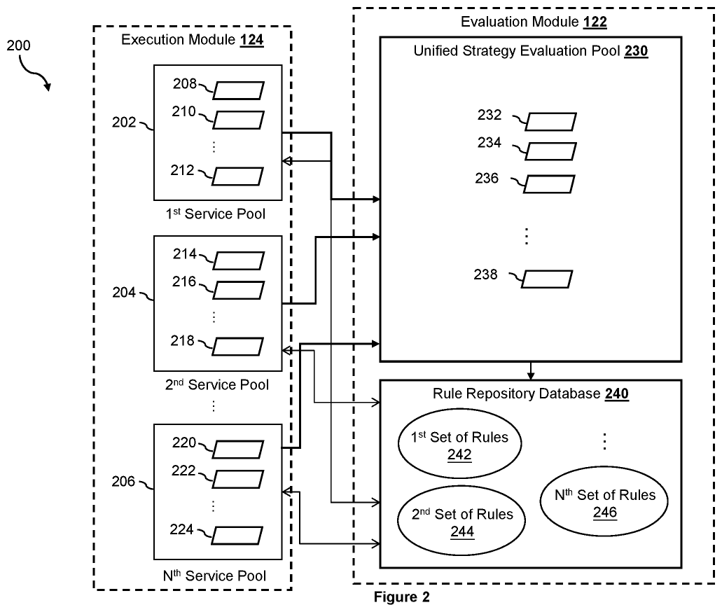

FIG. 2 illustrates an exemplary data flow 200 for evaluating one or more strategies at the evaluation module 122 according to various embodiments of the disclosure. In some embodiments, the exemplary data flow 200 may be performed by the evaluation module 122 and the execution module 124 at the server 120 (as shown in FIG. 1). In a process of evaluating the strategies, the execution module 124 may include a set of service pools providing various services, including a first service pool 202, a second service pool 204 to a N^{th} service pool 206. Each service pool may provide a corresponding service. For example, the first service pool 202 may provide a service of sending a payment to a third party which is reside outside of the server 120, and the second service pool 204 may provide a service of purchase items from a shopping website. The execution module 124 may send requests (e.g., a request that is duplicated from the request received at a service pool) received at each service pool to the evaluation module 122 to evaluate a strategy (e.g., a decision to deny a transaction request that fulfills a certain criteria).

The execution module 124 may include the first service pool 202, the second service pool 204, on so on to the N^{th} service pool 206 providing various services. For example, the first service pool 202 may be a service to authenticate a login requested from the user 150 from the user device 110, the second service pool 204 may be a service to determine whether the user 150 associated with the user device 110 is a fraudster, and the N^{th} service pool may be a service to determine a credit line for the user 150. Each of the service pools may include one or more instances of the decision service, application or the like that may be running or executing to process and/or perform the associated task and/or request (e.g., a login request to a PayPal® account, a request to make a payment which is requested by the user 150 via the user device 110, an application for a PayPal® credit card, etc.). For example, the first service pool 202 may provide a service of sending a payment to a third party. The first service pool 202 may include a first instance 208, a second instance 210, and so on to a N^{th} instance 212, which represent different instances of the service associated with the first service pool 202 processing requests from users, e.g., the first instance 208 may indicate a request made by the user 150 using the user device 110 to send payment to another user. In some embodiments, the second service pool 204 for a second service may include a first instance 214, a second instance 216, and so on to a N^{th} instance 218 which represent different instances of the service associated with the second service pool 204 processing requests from users. The N^{th} service pool 206 for a N^{th} service may include a first instance 220, a second instance 222, and so on to a N^{th} instance 224 which represent different instances of the service associated with the N^{th} service pool 206 processing requests from users. For example, the second service pool 204 may be a service to authenticate a login request for a PayPal application. The first instance 214 may be a login request sent by the user 150 via the user device 110, the second instance 216 may be a login request made by a second user via a website browser via a laptop of the second user, and the N^{th} instance 218 may be a login request made by a third user via the website browser using a desktop computer.

While each of the service pools is processing instances of a computing task, application, or process (e.g., purchasing an item from a website), the evaluation module 122 may evaluate a strategy/decision based on instances (e.g., generic instances for executing and evaluating strategies), and/or evaluate the results or performance of a strategy that has been deployed at the service pools. For example, the evaluation module 122 may evaluate a new strategy, e.g., checking a location where the login request is sent from, as well as the performance, accuracy, or the like of new and/or existing strategies.

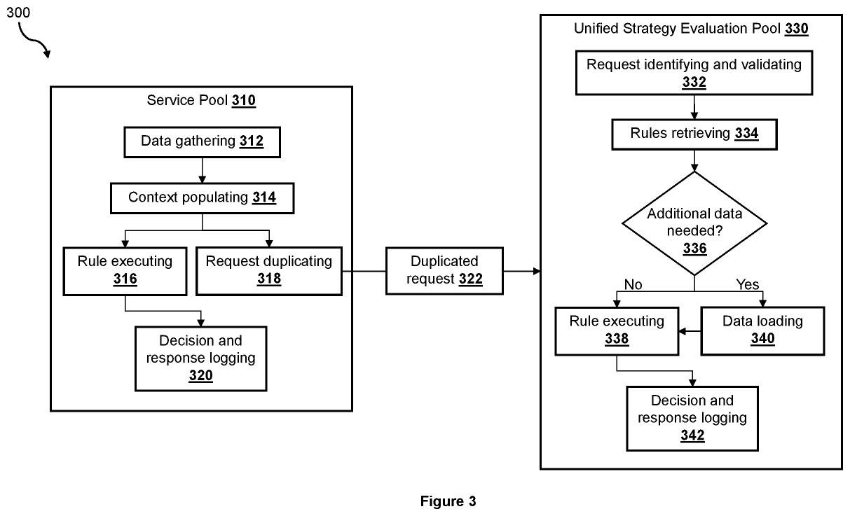

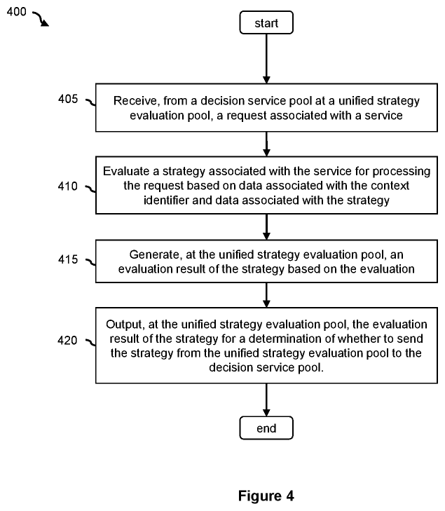

The evaluation module 122 may include a unified strategy evaluation pool 230 and a rule repository database 240. The unified strategy evaluation pool 230 may evaluate a strategy for a service deployed at a corresponding service pool. For example, the unified strategy evaluation pool 230 may include generic instances 232-238 that are able to execute and evaluate strategies for different service pools and/or any requests associated with different services. In some embodiments, the unified strategy evaluation pool 230 may receive the duplicated requests from different service pools (e.g., the first service pool 202, the second service pool 204, the N^{th} service pool 206, etc.) asynchronously. The unified strategy evaluation pool 230 may evaluate a strategy for the service of the service pool where the duplicated request is sent from, and then evaluate the strategy using the duplicated requests. The actions and the approaches related to the strategy evaluation will be further described in detail in FIGS. 3-4.

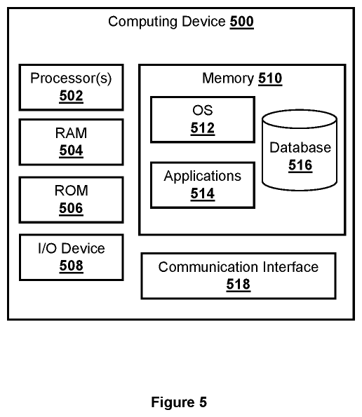

The rule repository database 240 of the evaluation module 122 may store multiple sets of rules corresponding to different services for examining instances received at its corresponding service pool, and/or retrieve rules for whether the strategy may be allowed to be executed at the service pool. For example, the first service pool 202 May have a corresponding first set of rules 242, the second service pool 204 may have a corresponding second set of rules 244, and the N^{th} service pool 206 may have a corresponding third set of rules 246, and so on. In some embodiments, the rules may be retrieved from the database 130. In some embodiments, the rules may be retrieved from an internal database (e.g., a storage and/or a memory 510 shown in FIG. 5). For example, a first set of rules 242 associated with the first service provided by the first service pool 202 may be used to examine whether the strategy is executable/implementable at the first service pool 202. In some embodiments, the first set of rules 242 may be associated with the strategy. The first service may be a service for transferring a payment to another entity (a user 150 or an organization), and the first set of rules 242 associated with the first service may include a limited amount of payment that can be made, a specific window for transferring a payment, etc. Rules may be included in one or more strategies, where strategies may correspond to bundles of one or more rules using by decision services to execute or make a decision, perform an action, process a request, or the like.

Due to a dynamic change in reality and/or a potential fraud, a user 150 (e.g., an administrator of a service provider or other strategy owner) may consider adding a new strategy (e.g., a new rule to an existing strategy, an exchange of existing rules, a deletion of a rule, etc.) or modifying an existing strategy when processing requests by the first service (e.g., the service for transferring the payment from one party to another party), such that the user 150 may utilize the unified strategy evaluation pool 230 to evaluate the new strategy and/or the existing strategy. For example, the unified strategy evaluation pool 230 may evaluate a new strategy of checking account balance of the sender's account before processing transferring the payment the receipt's account before the new strategy is being applied to the first service pool 202. When a strategy is determined/proposed by the unified strategy evaluation pool 230, the strategy may be sent to the rule repository database 240 to further be stored at the rule repository database 240, to be added with the first set of rules (e.g., the existing set of rules), and/or to be determined whether the strategy is against any one of the first set of rules 242 that have been setup for the first service. For example, the unified strategy evaluation pool 230 may evaluate a revenue that the new strategy might be bringing or losing after implementing the new strategy at the first service pool 202.

If, based on the evaluation of the new strategy, the new strategy is determined to be suitable to be deployed at the first service pool 202, the new strategy may be sent to the rule repository database 240 to be added with the first set of rules 242, and/or to be stored at the rule repository database 240 until applying to the first service pool 202. The deployment of the new strategy with rule repository database 240 may be based on instructions made by the user 150 (e.g., the administrator or strategy owner of the service provider). In some embodiments, if there is a rule in the strategy (e.g., no transaction can be made between 12 AM and 5 AM) that is not being complied with for processing the service or being against the existing rules associated with the service, the rule repository database 240 may not send the strategy to the first service pool 202 to be executed. Accordingly, if there is no rule being violated, the rule repository database 240 may send the strategy to its corresponding service pool (e.g., the first service pool 202). In some embodiments, the rule repository database 240 may store/retrieve one or more sets of rules corresponding to different services (e.g., a second set of rules 244 corresponding to the second service, and/or a N^{th} set of rules 246 corresponding to the N^{th} service) simultaneously, such that the rule repository database 240 may process examining one or more strategies associated with different services at the same time before executing at their corresponding service pools. Therefore, the system 100 for evaluating a strategy at a unified strategy evaluation pool may improve computing performance by alleviating traffic collision/jam at the service pool.

FIG. 3 illustrates an exemplary data flow 300 for evaluating one or more strategies at a unified strategy evaluation pool 330 according to various embodiments of the disclosure. The system 100 may have two environments, including a service pool 310 and the unified strategy evaluation pool 330 to perform the data flow 300. The service pool 310 may be an environment for processing requests received from one or more entities (e.g., the user 150 and/or a merchant), and the unified strategy evaluation pool 330 may be an environment for evaluating a strategy for the request. The service pool 310 and the unified strategy evaluation pool 330 may be operated independently. In some embodiments, the service pool 310 may provide a part of traffic (e.g., bandwidth and/or capacity of computing) to the unified strategy evaluation pool 330 for evaluating the strategy. In some embodiments, the service pool 310 may include a group of service pools, and each of the service pools may provide a specific service, such as making a payment, purchasing an item, establishing an account, etc.

The service pool 310 may receive a request associated with a service (e.g., a request of transferring an amount of $5,000 from Bank A to Bank B) sent from the user device 110 made by the user 150, and gather data 312 associated with the request (e.g., metadata including current or historical information about the execution times of the decision service). The service pool 310 may then populate context 314 in response to the gathered data associated with the request, such as a workflow to process the request. In some embodiments, the service pool 310 may proceed with processing the request, e.g., executing rules to the request 316, and duplicating the request 318 that is going to be sent to the unified strategy evaluation pool 330 for evaluation synchronously. In some embodiments, processing the request 316 and duplicating the request 318 may be performed at the same time.

For processing the request, the service pool 310 may execute the rules to the request 316 to determine whether the request complies with the rules. If there is no rule against the request (e.g., the amount of payment is under the limit set in the rules associated with the service provided by the service pool 310), the service pool 310 may generate a decision (e.g., proceeding with the request) and log response 320 in response to results of executing the rules.

For duplicating the request 318, the service pool 310 may generate a duplicated request based on the request received at the service pool 310, and send the duplicated request 322 to the unified strategy evaluation pool 330 for a further process (e.g., evaluating a strategy for the request using the duplicated request). In some embodiments, the duplicated request may include a first identifier that is associated with the workflow populated at the service pool 310, and a second identifier that is associated with the request.

The unified strategy evaluation pool 330 may identify and validate the duplicated request 332 when receiving the duplicated request from the service pool 310. In some embodiments, the unified strategy evaluation pool 330 may validate the duplicated request by identifying the first identifier (e.g., the identifier associated with the workflow generated based on the request) and the second identifier (e.g., the identifier associated with the request), such that the unified strategy evaluation pool 330 may validate that the duplicated request is associated with the service provided at the service pool 310, and determine a strategy (e.g., a modification to an existing strategy in response to its performance, and/or a strategy in response to a new fraud pattern) in response to the duplicated request. In some embodiments, the unified strategy evaluation pool 330 may retrieve rules associated with the service 334, e.g., from the database 130, to evaluate the strategy. In some embodiments, the unified strategy evaluation pool 330 may determine whether additional data (e.g., an additional transaction history associated with the duplicated request) is needed 336 to determine whether the strategy is applicable at the service pool 310. If the additional data is not needed, the unified strategy evaluation pool 330 may proceed with evaluating the strategy (e.g., executing rules in the strategy 338 in a simulated production environment similar to the service pool 310) by performing a series of efficiency tests, including testing the performance of the strategy, fire rate, action rate, decision quality and fraud pressure tuning, resource utilization, etc., to the strategy.

In some embodiments, if the additional data is needed, the unified strategy evaluation pool 330 may load the additional data 340 from a data source (e.g., the database 130), and then executing the rules (e.g., the rules included in the strategy) based on the data associated with the duplicated request and the additional data to test/run the strategy 338 to determine whether the strategy is applicable at the service pool 310. For example, if the evaluation of the strategy indicates a better accuracy of targeting a fraud user (e.g., a strategy of validating the user 150 through a text message), the unified strategy evaluation pool 330 may store the strategy, and/or add the strategy with the existing rules corresponding to the service, and further log a decision and a response 342 (e.g., a decision to deploy the strategy). In some embodiments, if there is no rule (included in the strategy) against the request (e.g., an adjusted time slot to make a payment requested in the duplicated request when the amount of the payment is over $5,000), the service pool 310 may generate a decision (e.g., proceeding with the request with the adjusted time slot) and log the response 342 in response to results of evaluating the strategy.

In this regard, the unified strategy evaluation pool 330 may independently examine and evaluate any strategies for different service pools (e.g., the service pool 310), which can propose a new strategy dynamically in response a potentially new fraud pattern. Therefore, the processing speed and performance of the machine learning model may be improved, and the service pool 310 may generate outputs (e.g., deploying a new strategy, discard an existing strategy if the evaluation is bad, and/or proceeding with the request) more efficiently and securely.

FIG. 4 illustrates an exemplary process 400 for evaluating a strategy at a unified strategy evaluation pool according to various embodiments of the disclosure. In some embodiments, at least a portion of the process 400 may be performed by the evaluation module 122 and the execution module 124, and apply approaches discussed in FIGS. 1-3.

The process 400 begins by receiving, (at step 405) from a decision service pool at a unified strategy evaluation pool, a request associated with a service. In some embodiments, the request may include a context identifier associated with the service, and the unified strategy evaluation pool may evaluate the request which is performed independently from the decision service pool. In such case, the process 400 may generate the request based on an original request (e.g., a parent request made by a user) received at the decision service pool.

In some embodiments, the request may further include a request identifier and a parent request identifier, such that the process 400 may further include determining whether the request identifier matches the parent request identifier, and, in response to determining that the request identifier matches the parent request identifier, validating that the request is associated with the service.

The process 400 evaluates (at step 410) a strategy associated with the service for processing the request based on data associated with the context identifier and data associated with the strategy. The strategy may include a set of rules for evaluating the request and/or a risk for processing the service. In some embodiments, the data associated with the context identifier may include metadata associated with the service. In some embodiments, the process 400 may further generate a key and a value based on a hash for the data associated with the context identifier. The key may include a context associated with the parent request, and the value may include the parent request identifier. The process 400 may further retrieve the context associated with the parent request based on the key and the value. The generated key and the value may facilitate the process 400 in terms of processing speed and efficiency. In some embodiments, in response to the evaluating step, the process 400 may retrieve additional data associated with the strategy if needed, and further re-evaluate the strategy based on the additional data associated with the strategy. For example, the strategy may include adjusting a transaction time if the amount of transfer exceeds a certain amount proposed in the strategy.

The process 400 generates (at step 415) an evaluation result of the strategy based on the evaluation. In some embodiments, the process 400 may retrieve a set of rules from an internal or external database that stores rules associated with a corresponding decision service.

The process 400 outputs (at step 420), at the unified strategy evaluation pool, the evaluation result of the strategy for a determination of whether to send the strategy from the unified strategy evaluation pool to the decision service pool. In some embodiments, if the evaluation result of the strategy indicates that the strategy is suitable/applicable at the decision service pool, the unified strategy evaluation pool may send the strategy to the decision service pool to be deployed at the decision service pool. In some embodiments, if the evaluation result of the strategy indicates that the strategy is not suitable/applicable at the decision service pool, the unified strategy evaluation pool may discard the strategy and not deploy the strategy at the decision service pool.

In some embodiments, the process 400 may utilize a part of traffic divided from a main traffic for processing the parent request at the decision service pool to process the request at the unified strategy evaluation pool, such that the main traffic at the decision service pool may not be impacted.

FIG. 5 illustrates a computing device 500 that may be used to implement the server 120, the user device 110, and the database 130 according to various embodiments of the disclosure. For example, the computing device 500 may be the server 120 performing the actions disclosed in FIGS. 2 to 4. The computing device 500 may include a processor 502 for controlling overall operation of the computing device 500 and its associated components, including a random access memory (RAM) 504, a read only memory (ROM) 506, an input/output (I/O) device 508, a communication interface 518, and/or a memory 510. A data bus may interconnect the processor(s) 502, the RAM 504, the ROM 506, the memory 510, the I/O device 508, and/or the communication interface 518. In some embodiments, the computing device 500 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

The input/output (I/O) device 508 may include a microphone, keypad, touch screen, and/or stylus motion, gesture, through which a user of the computing device 500 may provide input. The I/O device 508 may also include one or more of a speaker for providing audio output and a video display device for providing textual, audiovisual, and/or graphical output. Software may be stored within the memory 510 to provide instructions to the processor(s) 502 allowing the computing device 500 to perform various actions. For example, the memory 510 may store software used by the computing device 500, such as an operating system (OS) 512, application programs 514, an associated internal database 516, and/or any software that implements the process 400 as described herein. The various hardware memory units in the memory 510 may include volatile and nonvolatile, removable and non-removable media implemented in any method or technology for storage of information such as computer-readable instructions, data structures, program modules, or other data. The memory 510 may include one or more physical persistent memory devices and/or one or more non-persistent memory devices. The memory 510 may include, but is not limited to, a RAM, a ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor(s) 502.

The communication interface 518 may include one or more transceivers, digital signal processors, and/or additional circuitry and software for communicating via any network, wired or wireless, using any protocol as described herein.

The processor(s) 502 may include a single central processing unit (CPU), e.g., a single-core or multi-core processor, or may include multiple CPUs. The processor(s) 502 and associated components may allow the computing device 500 to execute a series of computer-readable instructions to perform some or all of the processes described herein. Although not shown in FIG. 5, various elements within the memory 510 or other components in computing device 500, may include one or more caches, for example, CPU caches used by the processor(s) 502, page caches used by the operating system 512, disk caches of a hard drive, and/or database caches used to cache content from the database 516. In various embodiments, the database 516 may be the database 130 described in FIG. 1. For embodiments including a CPU cache, the CPU cache may be used by the processor(s) 502 to reduce memory latency and access time. The processor(s) 502 may retrieve data from or write data to the CPU cache rather than reading/writing to the memory 510, which may improve the speed of these operations. In some embodiments, a database cache may be created in which certain data from the database 516 is cached in a separate smaller database in a memory separate from the database 516, such as in the RAM 504 or on a separate computing device. For instance, in a multi-tiered application, a database cache on an application server may reduce data retrieval and data manipulation time by not needing to communicate over a network (e.g., the network 140 described in FIG. 1) with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 500 are described separately, functionality of the various components may be combined and/or performed by a single component and/or multiple computing devices in communication without departing from the invention.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled with the non-transitory memory and configured to read instructions from the non-transitory memory to cause the system to perform operations comprising:
receiving, from a decision service pool at a unified strategy evaluation pool, a request associated with a service, wherein the request comprises a context identifier associated with the service, and wherein the unified strategy evaluation pool evaluates the request which is performed independently from the decision service pool;
evaluating, at the unified strategy evaluation pool, a strategy associated with the service for processing the request based on data associated with the context identifier and data associated with the strategy, wherein the strategy comprises a set of rules for evaluating the request;
generating, at the unified strategy evaluation pool, an evaluation result of the strategy based on the evaluating; and
outputting, at the unified strategy evaluation pool, the evaluation result of the strategy for a determination of whether to send the strategy from the unified strategy evaluation pool to the decision service pool.

2. The system of claim 1, wherein the request is duplicated from a parent request received at the decision service pool, the request further comprising a request identifier and a parent request identifier.

3. The system of claim 2, wherein the operations comprise:
determining whether the request identifier matches the parent request identifier; and
in response to determining that the request identifier matches the parent request identifier, validating that the request is associated with the service.

4. The system of claim 1, wherein the operations further comprise:
in response to the evaluating, retrieving additional data associated with the strategy; and
further re-evaluating the strategy based on the additional data associated with the strategy.

5. The system of claim 2, wherein the operations comprise:
generating a key and a value based on a hash for the data associated with the context identifier, wherein the key comprises a context associated with the parent request and the value comprises the parent request identifier; and
retrieving the context associated with the parent request based on the key and the value.

6. The system of claim 2, wherein the operations comprise:
utilizing a part of traffic for processing the request, wherein the part of traffic is divided from a main traffic for processing the parent request.

7. The system of claim 1, wherein the data associated with the context identifier comprises metadata associated with the service.

8. A method, comprising:
receiving, from a decision service pool at a unified strategy evaluation pool, a request associated with a service, wherein the request comprises a context identifier associated with the service;
evaluating, at the unified strategy evaluation pool, a strategy associated with the service for processing the request based on data associated with the context identifier and data associated with the strategy;
retrieving, at the unified strategy evaluation pool, a set of rules associated with the strategy, wherein the set of rules comprises one or more criteria for evaluating the request;
providing, at the unified strategy evaluation pool, an evaluation result of the strategy based on the evaluating the strategy; and
sending, to the decision service pool from the unified strategy evaluation pool, the strategy based on the evaluation result of the strategy.

9. The method of claim 8, further comprising:
receiving, from a second decision service pool, a second request associated with a second service, wherein the second request comprises a second context identifier associated with the second service;
evaluating a second strategy associated with the second service for processing the second request based on second data associated with the second context identifier and second data associated with the second strategy, wherein the identifying the second strategy and the identifying the strategy are performed asynchronously;
retrieving a second set of rules associated with the second strategy, wherein the retrieving the second set of rules and the retrieving the set of rules are performed synchronously;
providing, at the unified strategy evaluation pool, an evaluation result of the second strategy based on the evaluating the second strategy; and
sending, to the second decision service pool, the second strategy based on the evaluation result of the second strategy.

10. The method of claim 8, wherein the request is duplicated from a parent request received at the decision service pool, the request further comprising a request identifier and a parent request identifier.

11. The method of claim 10, further comprising:
determining whether the request identifier matches the parent request identifier; and
in response to determining that the request identifier matches the parent request identifier, validating that the request is associated with the service.

12. The method of claim 8, further comprising:
in response to the evaluating, retrieving additional data associated with the strategy; and
further re-evaluating the strategy based on the additional data associated with the strategy.

13. The method of claim 10, comprising:
utilizing a part of traffic for processing the request, wherein the part of traffic is divided from a main traffic for processing the parent request.

14. The method of claim 8, wherein the data associated with the context identifier comprises metadata associated with the service.

15. A non-transitory machine-readable medium having stored thereon machine-readable instructions executable to cause a machine to perform operations comprising:
receiving, from one or more decision service pools at a unified strategy evaluation pool, one or more requests individually, wherein each of the one or more requests comprises a context identifier associated with a service;
for each one of the one or more requests:
evaluating, at the unified strategy evaluation pool, a strategy associated with the service for processing the request based on data associated with the context identifier and data associated with the strategy;
retrieving, at the unified strategy evaluation pool, a set of rules associated with the strategy, wherein the set of rules comprises one or more criteria for evaluating the request; and
providing, at the unified strategy evaluation pool, an evaluation result of the strategy based on the evaluating; and
sending, to the one or more decision service pools from the unified strategy evaluation pool, the strategy based on the evaluation result of the strategy individually.

16. The non-transitory machine-readable medium of claim 15, wherein the request is duplicated from a parent request received at a corresponding decision service pool of the one or more decision service pools, the request further comprising a request identifier and a parent request identifier.

17. The non-transitory machine-readable medium of claim 16, wherein the operations further comprise:
determining whether the request identifier matches the parent request identifier; and
in response to determining that the request identifier matches the parent request identifier, validating that the request is associated with the service.

18. The non-transitory machine-readable medium of claim 15, wherein the operations further comprise:
for each one of the one or more requests:
in response to the evaluating, retrieving additional data associated with the strategy; and
further re-evaluating the strategy based on the additional data associated with the strategy.

19. The non-transitory machine-readable medium of claim 16, wherein the operations further comprise:
utilizing a part of traffic for processing the request, wherein the part of traffic is divided from a main traffic for processing the parent request.

20. The non-transitory machine-readable medium of claim 15, wherein the data associated with the context identifier comprises metadata associated with the service.
